(19) United States
(12) Patent Application Publication
(10) Pub. No.: US 2020/0106902 A1
(43) Pub. Date: Apr. 2, 2020

(54) DISPLAY DEVICE, STORAGE MEDIUM STORING CONTROL PROGRAM FOR DISPLAY DEVICE, AND METHOD OF CONTROLLING DISPLAY DEVICE

(71) Applicant: SHARP KABUSHIKI KAISHA, Osaka (JP)

(72) Inventor: TSUTOMU ITAI, Osaka (JP)

(21) Appl. No.: 16/586,668

(22) Filed: Sep. 27, 2019

(30) Foreign Application Priority Data
Sep. 28, 2018 (JP) 2018-184824

(51) Int. Cl. H04N 1/00

(52) U.S. Cl. CPC H04N 1/00477; H04N 1/00384; H04N 1/00509

(57) ABSTRACT

An image forming apparatus including a display is provided. When events involving with the image forming apparatus are occurring and a predetermined event about which the user should be notified is occurring, notification windows including messages corresponding to the events are displayed on the display. At least one of the notification windows includes a first key, and all of the notification windows are hidden when the first key is operated.

### BACKGROUND OF THE INVENTION

### Field of the Invention

The present invention relates to a display device, a storage medium storing a control program for the display device, and a method of controlling the display device, and in particular, to a display device including a display unit and causing a notification window for notifying a user of predetermined information to be displayed on the display unit, a storage medium storing a control program for the display device, and a method of controlling the display device.

### Description of the Background Art

An example of such background art is disclosed in Japanese Unexamined Patent Application Publication No. 2000-305687. In an interactive display device according to the background art, pop-up windows including messages whose contents correspond to the processing statuses of a functional processor that executes various processes are displayed on a display unit. In the case where messages having different contents are to be displayed in multiple pop-up windows, the pop-up windows are overlappingly displayed in an order in accordance with the levels of priority of respective message types.

Each window is provided with a confirmation button. When an operator operates the confirmation button of the frontmost window, the frontmost window is closed, and the window behind the frontmost window is displayed as a new frontmost window.

However, in the interactive display device according to the background art, to hide all of the notification windows, it is necessary to operate the confirmation button in every notification window. Thus, in the case where many displayed notification windows are to be closed, the confirmation button of each notification window has to be operated, and this is troublesome.

Thus, a main object of the present invention is to provide a novel image forming apparatus, display device, control program, and controlling method.

Another object of the present invention is to provide an image forming apparatus, a display device, a control program, and a control method capable of readily hiding multiple displayed notification windows.

### SUMMARY OF THE INVENTION

According to a first aspect of the present invention, a display device including a display having a display surface includes a notifier and a display controller. The notifier displays windows including messages on the display surface. The display controller hides all of the windows displayed on the display surface when a first key provided on at least one of the windows is operated.

According to a second aspect of the present invention, in the display device according to the first aspect, the notifier of overlappingly displays the windows, and the first key is provided on at least the frontmost window.

According to a third aspect of the present invention, in the display device according to the second aspect, the messages are assigned levels of priority, and the notifier displays the windows in accordance with an order of display corresponding to the levels of priority.

According to a fourth aspect of the present invention, in the display device according to the second aspect, the frontmost window is provided with a second key, and the display controller hides the frontmost window when the second key is operated.

According to a fifth aspect of the present invention, in the display device according to the first aspect, at least one of the windows is provided with a second key; and the display controllers hides the window provided with the second key when the second key is operated.

According to a sixth aspect of the present invention, in the display device according to the fifth aspect, at least one of the windows is provided with the first key and the second key.

According to a seventh aspect of the present invention, an image forming apparatus includes the display device according to the first aspect. The display device includes the notifier displays, on the display surface, windows including messages corresponding to events involving the image forming apparatus, while the events are occurring.

According to an eighth aspect of the present invention, a storage medium stores a control program for a display device including a display having a display surface, the control program causing a processor of the display device to function as a notifier that displays windows including messages on the display surface; and a display controller that hides all of the windows displayed on the display surface when a first key provided on at least one of the windows is operated.

According to a ninth aspect of the present invention, a method of controlling a display device including a display having a display surface includes (a) displaying windows including messages on the display surface; and (b) hiding all of the windows displayed on the display surface when a first key provided on at least one of the windows is operated.

According to the aspects of the present invention, multiple notification windows being displayed can be readily hidden.

The above-described objects, other objects, features, and advantages of the present invention will become more apparent from the detailed descriptions of the following embodiments given with reference to the drawings.

### BRIEF DESCRIPTION OF THE DRAWINGS

FIG. 1 is a perspective view of the external appearance of an image forming apparatus according to an embodiment of the present invention;

FIG. 2 is a block diagram illustrating an electrical configuration of the image forming apparatus illustrated in FIG. 1;

FIG. 3 is an illustrative view of an example of a home menu;

FIG. 4 is an illustrative view of an example of a home menu including a first-type notification window;

FIG. 5 is an illustrative view of an example of a message table;

FIG. 6 is an illustrative view of an example of a memory map of a random-access memory (RAM) illustrated in FIG. 2;

FIG. 7 is a flowchart illustrating an example of a notification process for a central processing unit (CPU) illustrated in FIG. 2;

FIG. 8 is a flowchart illustrating an example of a flag switching process for the CPU illustrated in FIG. 2;

FIG. 9 is an illustrative view of an example of a home menu including a second-type notification window according to a second embodiment;

FIG. 10 is a flowchart illustrating a portion of an example of a notification process according to the second embodiment;

FIG. 11 is an illustrative view of an example of a message table according to a third embodiment;

FIG. 12 is a flowchart illustrating a portion of an example of a notification process according to the third embodiment;

FIG. 13 is an illustrative view of an example of a home menu including a third-type notification window according to a fourth embodiment;

FIG. 14 is a flowchart illustrating a portion of an example of a notification process according to the fourth embodiment;

FIG. 15 is an illustrative view of an example of a home menu including a third-type notification window according to a modification;

FIG. 16 is an illustrative view of an example of a copy settings menu including a notification key according to a fifth embodiment;

FIG. 17 is an illustrative view of an example of a copy settings menu including a notification window according to the fifth embodiment;

FIG. 18 is a flowchart illustrating a portion of an example of a notification process according to the fifth embodiment; and

FIG. 19 is a flowchart illustrating an example of a flag switching process according to the fifth embodiment.

### DESCRIPTION OF THE PREFERRED EMBODIMENTS

### First Embodiment

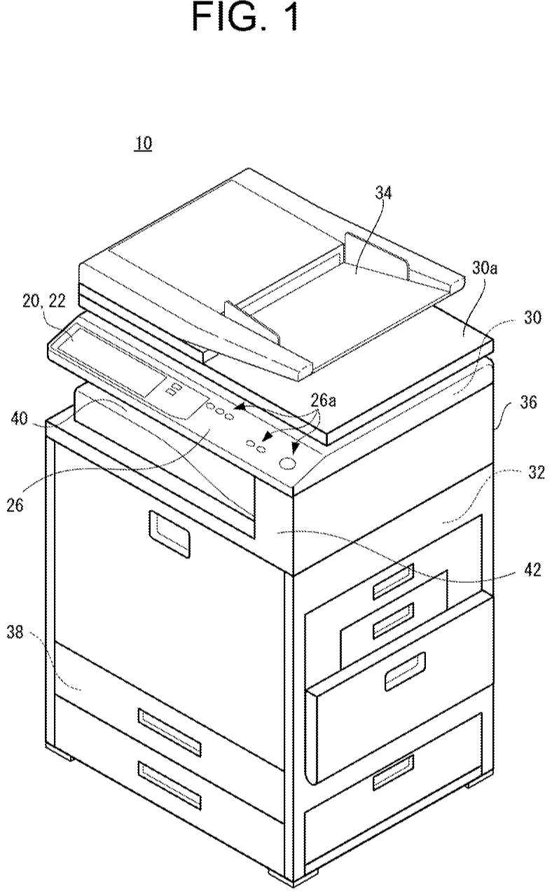

FIG. 1 is a perspective view of the external configuration of an image forming apparatus 10 according to an embodiment of the present invention. With reference to FIG. 1, the image forming apparatus 10 according to a first embodiment is a multifunction peripheral (MFP) having an image display function, as well as a copying function, a printer function, a scanner function, a facsimile function, and the like. The present invention is applicable not only to multifunction peripherals but also to other image forming apparatuses, such as copiers, printers, and facsimiles. The present invention is applicable not only to image forming apparatuses but also information equipment or electronic equipment having various image display functions, such as tablet terminals, smartphones, personal computers (PC), and digital tables. The present invention is also applicable to display devices, such as information displays and electronic blackboards.

Note that, in this specification, the front-back direction (depth direction) of the image forming apparatus 10 and its components is defined by determining the forward face (front face) to be a surface facing a standing user, that is, a face on which a later-described operation panel 26 is provided; and the left-right direction (transverse) of the image forming apparatus 10 and its components is defined on the basis of the point of view of the user viewing the image forming apparatus 10.

The image forming apparatus 10 includes a body 36 including an image reader 30, an image former 32, a sheet feeder 38, and a sheet receiving tray 40.

The image reader 30 includes a document placing table formed of a transparent material, and is accommodated in the body 36. A document holding cover 30a is attached to the upper portion of the document placing table so as to be freely opened and closed, via a hinge or the like. The document holding cover 30a is provided with a document tray 34. The document holding cover 30a is provided with an automatic document feeder (ADF) for automatically feeding the sheets placed on the document tray 34.

The image reader 30 includes a light source, multiple mirrors, an imaging lens, a line sensor, etc. The image reader 30 exposes the surface of a sheet with light from the light source, and guides the light reflected from the surface of the sheet to the imaging lens via the mirrors. The imaging lens then forms an image of the reflected light on a light receiving element of the line sensor. The line sensor detects the luminance or the chromaticity of the image of the reflected light formed on the light receiving element, and generates image data based on the image on the sheet face. The line sensor may be a charge coupled device (CCD), a contact image sensor (CIS), or the like.

The image former 32 is accommodated in the body 36, and is provided below the image reader 30. The image former 32 includes photosensitive drums, chargers, exposure units, developing units, transfer units, fixing units, etc. The image former 32 forms, using an electrophotographic method, images on recording media (sheets) transported from the sheet feeder 38, etc., and ejects the sheets on which images have been formed to the sheet receiving tray 40. Note that, print image data for forming images on sheets include image data read by the image reader 30, image data sent from an external computer, and the like. The recording medium is not limited to paper sheets. Sheets other than those made of paper, for example, overhead projector (OHP) films may be used.

Although a detailed description will be omitted, the image former 32 has a color printing function. Image forming stations each including a photosensitive drum, a charger, a developing unit, a transfer roller, and a cleaner are provided for the respective colors yellow (Y), magenta (M), cyan (C), and black (K). For example, the image forming apparatus 10 is a tandem type image forming apparatus, and in the image former 32, image forming stations for the respective colors are arrayed in a single line.

The sheet receiving tray 40 is disposed between the image reader 30 and the image former 32. The bottom face of the sheet receiving tray 40 is defined by the image former 32. The top face of the sheet receiving tray 40 is defined by the image reader 30. Furthermore, the right side face (right side face viewed from the front) of the sheet receiving tray 40 is defined by the left side face of a connection housing 42. That is, the sheet receiving tray 40 is open on the front side, the back side, and the left side. The bottom face of the sheet receiving tray 40 has an inclined face that slopes downward toward the connection housing 42.

The front side of the image reader 30 is provided with an operation panel 26. The operation panel 26 includes a display 22 having a touch panel 20 and multiple operation buttons 26a.

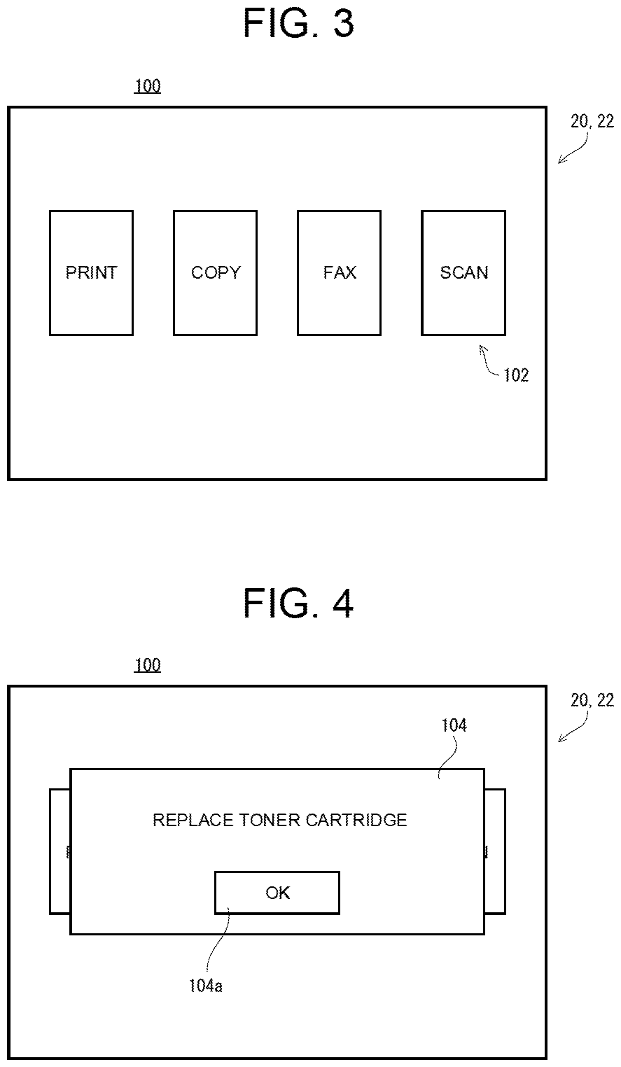

The display 22 having the touch panel 20 displays software keys for receiving various settings, print instructions, or the like from the user, and messages, etc. The display 22 displays various operation menus, such as a home menu 100 (see FIG. 3), for selecting a desired job among various jobs executable by the image forming apparatus 10. Note that, in the first embodiment, a job refers to copying (including scanning of a document), printing, sending of a facsimile, and the like.

The operation buttons 26a are hardware keys, and include, for example, a home key, a power saving key, and a main power key. The home key is a key for displaying the home menu on the display 22. The power saving key is a key for switching between a power saving state (power saving mode) in which power consumption is limited and a normal state (normal mode) in which power consumption is not limited. Alternatively, the operation buttons 26a may be software keys. In such a case, the operation buttons 26a are displayed on the display 22 having the touch panel 20.

Note that a software key is, for example, a key (icon) reproduced through software on the display surface of the display 22 having the touch panel 20. In contrast, a hardware key is a key (button) provided as a physical device. An operational input to the operation panel 26 refers to an operational input to any component of the operation panel 26, such as an operational input to a software key (for example, a touch input to the touch panel 20) and an operational input to a hardware key (button operation of any of the operation buttons 26a).

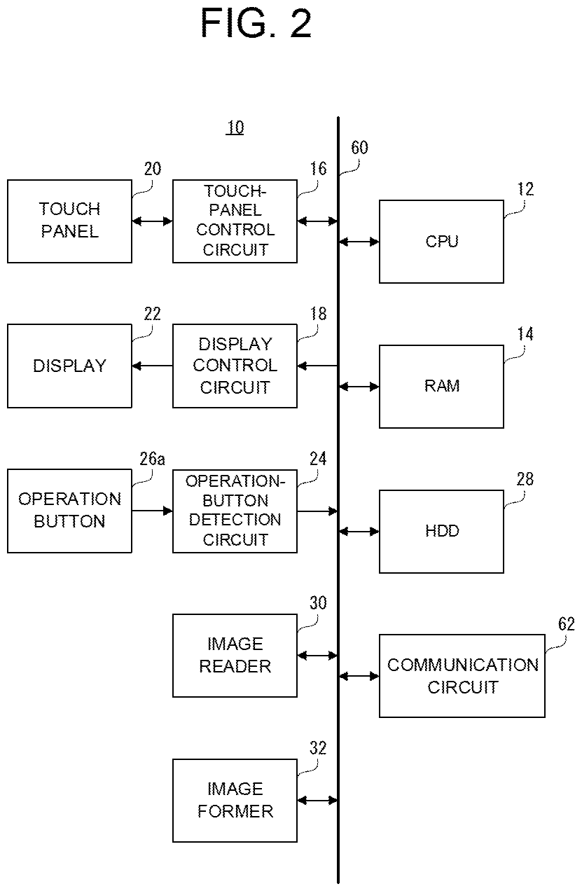

FIG. 2 is a block diagram illustrating an electrical configuration of the image forming apparatus 10 illustrated in FIG. 1. With reference to FIG. 2, the image forming apparatus 10 includes a CPU 12. The CPU 12 is connected, via a bus 60, to a RAM 14, a touch-panel control circuit 16, a display control circuit 18, an operation-button detection circuit 24, a hard disk drive (HDD) 28, an image reader 30, an image former 32, and a communication circuit 62. The touch-panel control circuit 16 is connected with the touch panel 20. The display control circuit 18 is connected with the display 22. The operation-button detection circuit 24 is connected with the operation buttons 26a.

The CPU 12 comprehensively controls the image forming apparatus 10. The RAM 14 is used as a work area and a buffer area for the CPU 12.

The HDD 28 is a main storage device of the image forming apparatus 10, and appropriately stores control programs, various types of data, and the like for the CPU 12 to control the operation of the components of the image forming apparatus 10. Note that, another non-volatile memory, such as a solid-state drive (SSD), a flash memory, or an electrically erasable programmable read-only memory (EEPROM), may be used in place of or together with the HDD 28.

The touch-panel control circuit 16 applies a voltage and the like required by the touch panel 20, detects a touch operation (touch input) within an effective touch range of the touch panel 20, and outputs touch coordinate data indicating the position of the touch input to the CPU 12.

The touch panel 20 is a general-purpose touch panel, and may be of any type, such as a capacitive type, an electromagnetic type, a resistive type, or an infrared type. The touch panel 20 according to the first embodiment is a capacitive touch panel that is disposed on the display surface of the display 22. Alternatively, a touch panel display integrating the touch panel 20 and the display 22 may be used.

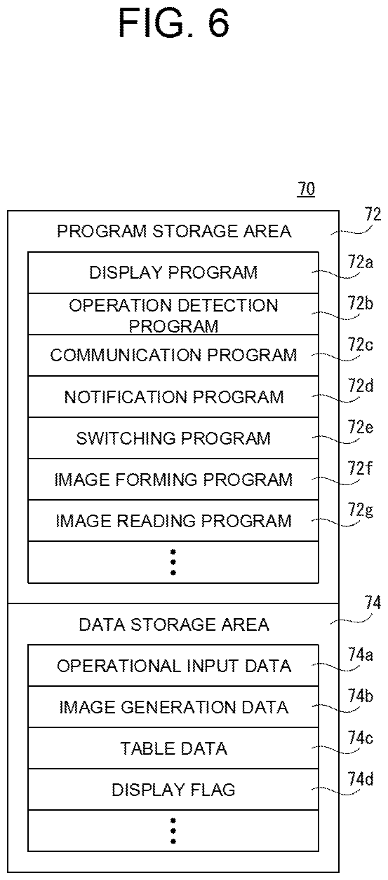

The display control circuit 18 includes a graphics processing unit (GPU), a video random access memory (VRAM), and the like. The GPU, under the instructions of the CPU 12, uses image generation data 74b (see FIG. 6) stored in the RAM 14, to generate, in the VRAM, display image data for displaying various menus on the display 22, and outputs the generated display image data to the display 22. The display 22 may be, for example, a liquid crystal display (LCD) or an electro-luminescence (EL) display.

The operation-button detection circuit 24 outputs, to the CPU 12, an operation signal or operation data corresponding to the operation of the above-described operation buttons 26a.

The communication circuit 62 establishes connection with a network, such as the Internet. The communication circuit 62 is a wired communication circuit or a wireless communication circuit, and communicates with an external computer via the network in accordance with an instruction from the CPU 12.

Note that the electrical configuration of the image forming apparatus 10 illustrated in FIG. 2 is a mere example, and should not be limited thereto. For example, the image forming apparatus 10 is provided with a jam sensor for detecting a paper jam in the image former 32, a sheet sensor for detecting the remaining number of sheets in the sheet feeder 38, and the like. The image forming apparatus 10 may also be provided with a connector, such as a memory slot to which various recording media, e.g., a secure digital (SD) card and a universal serial bus (USB) memory, can be inserted. Furthermore, the image forming apparatus 10 may be connected to input units besides the touch panel 20 and the operation buttons 26a, such as a pointing device, e.g., a computer mouse, a touch pad, a pen tablet, and the like, and may be connected with a hardware keyboard.

Some image forming apparatuses having such a configuration may display, on a display unit, pop-up windows including messages having contents corresponding to information related to the image forming apparatuses. In such an image forming apparatus, the pop-up windows are overlappingly displayed in an order in accordance with the levels of priority of respective message types. Every pop-up window is provided with a confirmation button for closing the pop-up window. When the operator operates the confirmation button in the frontmost pop-up window, the frontmost pop-up window closes, and the pop-up window behind the frontmost pop-up window becomes the new frontmost window.

However, in a typical image forming apparatus, the confirmation buttons in the windows need to be operated to hide every window. Thus, when many windows including messages are displayed, hiding all the windows is troublesome because every confirmation button in every window needs to be operated.

Thus, in the image forming apparatus 10 according to the first embodiment, some of the multiple notification windows overlappingly displayed are provided with keys for hiding all of the notification windows.

An operation example of the image forming apparatus 10 will now be described with reference to FIGS. 3 and 4. FIG. 3 is an illustrative view of an example of the home menu 100. FIG. 4 is an illustrated view of an example of the home menu 100 including a first-type notification window 104.

As described above, the image forming apparatus 10 is a multifunction peripheral having various functions, and can perform copy jobs, printing jobs, scan jobs, facsimile jobs, and the like. When the image forming apparatus 10 turned on and in a standby mode in which the respective functions are executable, the home menu 100, as illustrated in FIG. 3, is displayed on the display 22 of the image forming apparatus 10. The home menu 100 displays images of job selection keys (icons) 102 each for displaying an operation menu (settings menu) for selecting a job, such as copying, printing, sending a facsimile and scanning, and setting operation conditions, etc., for each job.

For example, the user can instruct the execution of a desired job by operating (touching) the corresponding job selection key 102. Thus, the image forming apparatus 10 executes each job under the instruction of the user.

When a predetermined event involving the image forming apparatus 10 is occurring and when the user should be notified of the predetermined event while the home menu 100 or any of the various settings menus is displayed on the display 22, as illustrated in FIG. 4, a first-type notification window 104 including a message corresponding to information on the event is displayed. Events about which the user should be notified include errors, such as paper out, toner out, and paper jam, job start/job end, user operation assistance, user operation acceptance, etc., in the image forming apparatus 10. The image forming apparatus 10 according to this embodiment is provided with multiple messages corresponding to respective events. A message corresponding to the event occurring in the image forming apparatus 10 is selected, and a first-type notification window 104 including the selected message is displayed.

The first-type notification window 104 overlaps the various menus, such as the home menu 100, and is displayed in the central area of the display region of the display 22. In the example illustrated in FIG. 4, the first-type notification window 104 is displayed in front of the home menu 100. That is, the first-type notification window 104 is displayed as a pop-up window. One first-type notification window 104 is displayed for each message. In other words, each first-type notification window 104 includes a single message. The same applies to second-type notification windows 106 and third-type notification windows 108 described in the second to fifth embodiments.

When multiple events are simultaneously occurring in the image forming apparatus 10, multiple messages corresponding to the respective events are displayed to notify the user. In such a case, multiple first-type notification windows 104 corresponding to the messages are simultaneously displayed. In other words, the number of the simultaneously displayed first-type notification windows 104 corresponds to the number of messages displayed to notify the user.

In the image forming apparatus 10 according to the first embodiment, the simultaneously displayed first-type notification windows 104 overlap each other. Furthermore, all of the first-type notification windows 104 are displayed at the same position. Thus, only the frontmost first-type notification window 104 is visible.

Note that the messages displayed in the first-type notification windows 104 are each assigned a level of priority. The level of priority of each message is appropriately assigned in accordance with the importance, the urgency, etc., of the content of the message, as well as the installation site, the use condition, etc., of the image forming apparatus 10. When multiple first-type notification windows 104 are overlappingly displayed, the first-type notification windows 104 are displayed in an order corresponding to the priority of the messages. The first-type notification windows 104 are displayed from the front side to back sides in an order that corresponds to a descending order of priority of the messages included in the first-type notification windows 104. Thus, the first-type notification windows 104 including messages having high priority are displayed more toward the front side than the first-type notification windows 104 including messages of low priority. In other words, the first-type notification window 104 including a message having the highest priority is displayed in the foreground.

In the first embodiment, a first key 104a, in addition to the above-described message, is provided (appears) in at least the frontmost first-type notification window 104. However, the first key 104a may also be provided in any of the first-type notification windows 104 other than the frontmost first-type notification window 104.

The first key 104a is assigned a function of hiding (closing) the frontmost first-type notification window 104 and the other first-type notification windows 104, that is, a function of hiding all of the notification windows. The same applies to the first key 108a described below.

Note that the only operation allowed on the first-type notification windows 104 is touching the first key 104a, and other operations (for example, touching the job selection key 102) are prohibited. When multiple first-type notification windows 104 are overlappingly displayed, the only operation allowed on the frontmost first-type notification window 104 is touching the first key 104a.

Touching the first key 104a hides all of the notification windows. That is, the home menu 100 as illustrated in FIG. 3 is displayed again. An example has been described in which the first-type notification windows 104 are displayed in front of the home menu 100. However, in the case where the first-type notification windows 104 are displayed in front of the various settings menu other than the home menu 100, touching the first key 104a causes the various settings menu to be displayed again. Thus, the user can execute a desired job by touching a corresponding job selection key 102. Once the first key 104a is touched, it is assumed that the user has been notified of the content of the message included in the frontmost first-type notification window 104, that is, the message is handled as a notified message (read message). After the user is notified of the message, the first-type notification window 104 including the notified message may be hidden, or may be displayed again while the event corresponding to the message continues to occur (while the event is not resolved).

If the event about which the user should be notified continues to occur after a predetermined time (for example, one minute) after the first key 104a is touched, the first-type notification windows 104 are displayed. In this case also, the first-type notification window 104 including the message having the highest priority is displayed in the foreground.

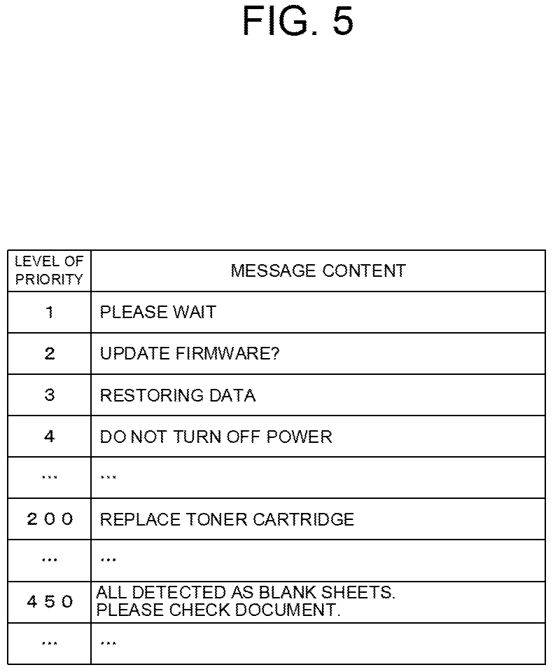

The priority of each message is determined using the message table illustrated in FIG. 5. FIG. 5 is an illustrative view of an example of a message table. The message table according to the first embodiment illustrated in FIG. 5 is prepared in advance, and the corresponding table data 74c (see FIG. 6) is stored in a predetermined storage destination, such as the HDD 28 of the image forming apparatus 10, an external server, or the like.

As illustrated in FIG. 5, the message table contains messages displayable on the image forming apparatus 10 and their corresponding levels of priority. In the first embodiment, there are approximately 500 types of messages displayable on the image forming apparatus 10, and their levels of priority are represented by numbers.

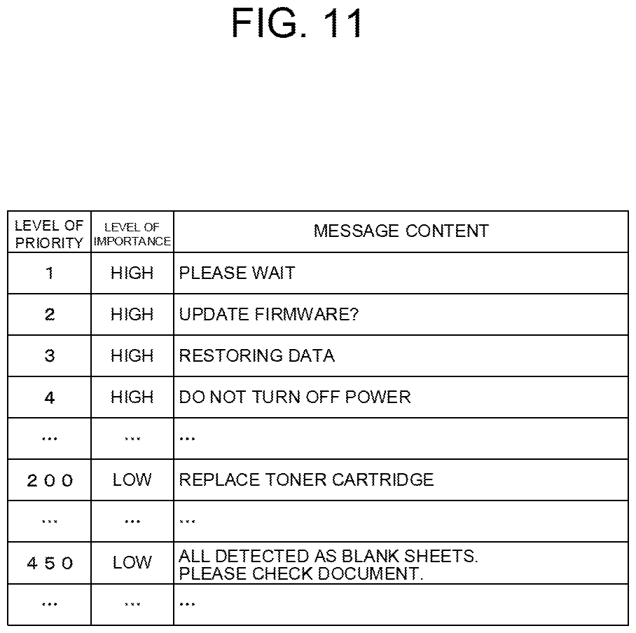

The respective columns of the message table illustrated in FIG. 5 contain character strings corresponding to the content of the respective messages and numbers indicating the levels of priority. The character strings and the numbers are used merely for internal processing by the image forming apparatus 10. Thus, the character strings and numbers in the columns of the message table may be described by symbols or the like indecipherable by humans. The above is also applicable to the message table according to the third embodiment illustrated in FIG. 11.

The above-described operation of the image forming apparatus 10 is achieved by the CPU 12 executing a control program stored in the RAM 14. The specific process will be described below using a flowchart.

FIG. 6 is an illustrative view of an example of a memory map 70 in the RAM 14 illustrated in FIG. 2. As illustrated in FIG. 6, the RAM 14 includes a program storage area 72 and a data storage area 74. As described above, the program storage area 72 of the RAM 14 stores the control program. The control program includes a display program 72a, an operation detection program 72b, a communication program 72c, a notification program 72d, a switching program 72e, an image forming program 72f, and an image reading program 72g.

The display program 72a uses the image generation data 74b described below to display various menus, such as the home menu 100, on the display 22. The display program 72a is also a program for displaying, on the display 22, a first-type notification window 104 including a selected message when an event about which the user should be notified is occurring. The display program 72a is also a program for displaying multiple first-type notification windows 104 in an order corresponding to the level of priority of the messages, when the multiple first-type notification windows 104 are simultaneously displayed.

The operation detection program 72b is a program for detecting operations to components of the image forming apparatus 10. For example, the operation detection program 72b is a program for acquiring touch coordinate data output from the touch panel 20 and detecting operation (touching) of the software keys included in the various menus displayed on the display 22. The operation detection program 72b is also a program for detecting an operational input from the operation buttons 26a.

The communication program 72c is a program for communicating with external computers via a network.

The notification program 72d is a program for selecting a message corresponding to an event about which the user should be notified, while the event is occurring.

The switching program 72e is a program for turning on/off a display flag 74d in response to an operation of the first key 104a. That is, the switching program 72e is a program for switching between a hidden state and a not hidden state of every first-type notification window 104.

The image forming program 72f is a program for controlling the image former 32 to print a multi-color or single-color image on a sheet.

The image reading program 72g is a program for controlling the image reader 30 to read an image of a document and output an image signal (image data) corresponding to the read image.

Although not illustrated, the program storage area 72 also stores programs for selecting and executing various functions of the image forming apparatus 10.

The data storage area 74 of the RAM 14 stores operational input data 74a, image generation data 74b, table data 74c, a display flag 74d, and the like.

The operational input data 74a is, for example, touch coordinate data and/or operation data detected (acquired) in accordance with the operation detection program 72b. The detected touch coordinate data and/or the operation data is stored in chronological order.

The image generation data 74b is polygon data, texture data, or the like for generating display image data corresponding to various menus, such as the home menu 100 and the first-type notification windows 104, appearing on the display 22. The image generation data 74b also includes, for example, image data of software keys, such as the first key 104a.

The table data 74c is data on the above-described message table, etc. As described above, the table data 74c is stored in a predetermined storage destination, such as the HDD 28 or an external server, read from the predetermined storage destination as needed, and stored in the RAM 14.

The display flag 74d is a flag for determining whether to display a first-type notification window 104. When the display flag 74d is turned on and an event about which the user should be notified is occurring (when it is determined that a notification is to be made), a first-type notification window 104 is displayed. In contrast, when an invalid flag 74e is turned off, a first-type notification window 104 is not displayed even when it is determined that a notification is to be made.

Although not illustrated, the data storage area 74 stores other data required for executing the control program, and is provided with a timer (counter) and a register required for executing the control program.

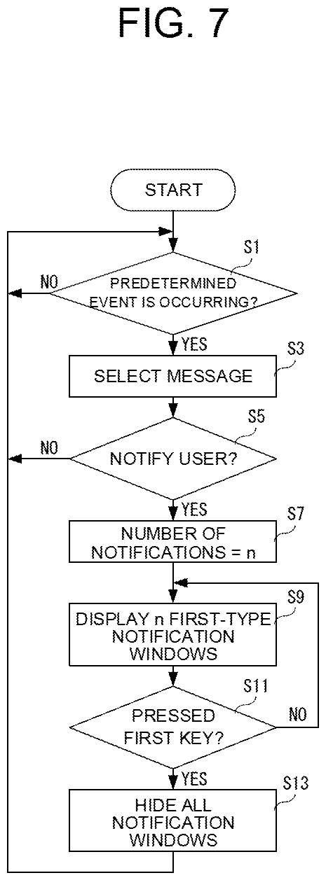

FIG. 7 is a flowchart illustrating an example of a notification process executed by the CPU 12 illustrated in FIG. 2. The notification process starts when the image forming apparatus 10 is turned on, and ends when the image forming apparatus 10 is turned off or when the image forming apparatus 10 is switched to a power saving state in which power consumption is limited.

As illustrated in FIG. 7, when the notification process starts, the CPU 12 determines, in step S1, whether an event about which the user should be notified is occurring. If “NO” in step S1, that is, if an event about which the user should be notified has not occurred, the CPU 12 then performs step S1 again. If “YES” in step S1, that is, if it is determined that an event about which the user should be notified is occurring, the CPU 12 selects a message corresponding to the event in step S3, and determines whether a notification should be made in step S5. Here, the CPU 12 determines whether the display flag 74d is turned on.

If “NO” in step S5, that is, if it is determined that the display flag 74d is turned off and a notification is not to be made, the CPU 12 performs step S1 again. If “YES” in step S5, that is, if it is determined that the display flag 74d is turned on and a notification is to be made, the CPU 12 substitutes the number of notifications to a variable n in step S7, and displays n first-type notification windows 104 on the display 22 in step S9. However, in the case where the variable n is two or more, that is, the number of notifications is two or more, the CPU 12 overlappingly displays the first-type notification windows 104 so as to display the first-type notification window 104 including the message having the highest priority in the foreground.

Then, in step S11, the CPU 12 determines whether the first key 104a has been touched. If “NO” in step S11, that is, if the CPU 12 determines that the first key 104a has not been touched, the CPU 12 then performs step S9 again. If “YES” in step S11, that is, if it is determined that the first key 104a has been touched, the CPU 12 hides all of the first-type notification windows 104 in step S13, and then performs step S1 again.

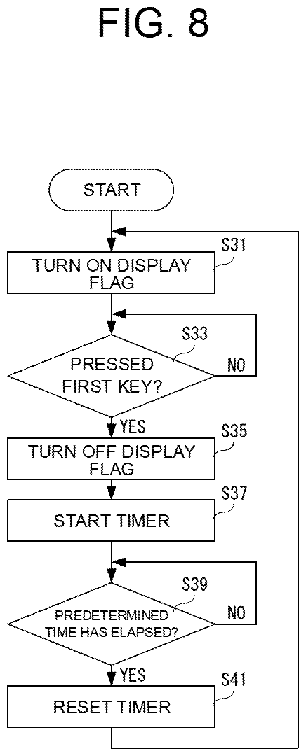

A flag switching process executed by the CPU 12 of the image forming apparatus 10 will now be explained. FIG. 8 is a flowchart illustrating an example of a flag switching process executed by the CPU 12 illustrated in FIG. 2. The flag switching process starts when the image forming apparatus 10 is turned on, and ends when the image forming apparatus 10 is turned off or when the image forming apparatus 10 is switched to a power saving state in which power consumption is limited. The flag switching process is executed in parallel with the notification process.

As illustrated in FIG. 8, when the flag switching process starts, the CPU 12 turns on the display flag 74d in step S31, and determines whether the first key 104a has been touched in step S33. If “NO” in step S33, that is, if it is determined that the first key 104a has not been touched, the process CPU 12 then performs step S33 again. If “YES” in step S33, that is, if it is determined that the first key 104a has been touched, the CPU 12 turns off the display flag 74d in step S35, and starts the timer in step S37. Although not illustrated, the timer is provided in the RAM 14. Then in step S39, the CPU 12 determines whether a predetermined time (for example, one minute) has elapsed. If “NO” in step S39, that is, if the predetermined time has not elapsed, the CPU 12 performs step S39 again. If “YES” in step S39, that is, if the predetermined time has elapsed, the CPU 12 resets the timer in step S41, and then performs step S31 again.

According to the first embodiment, when multiple notification windows 104 are displayed, touching the first key 104a provided in any of the notification windows 104 hides all of the notification windows 104. Thus, when multiple notification windows 104 are displayed, the notification windows can be readily hidden.

According to the first embodiment, when multiple notification windows 104 are overlappingly displayed, the first key 104a is provided in at least the frontmost notification window. Thus, when multiple notification windows are overlappingly displayed, the notification windows can be readily hidden.

According to the first embodiment, when the multiple messages are each assigned a predetermined level of priority, and multiple first-type notification windows 104 are overlappingly displayed, the order of display of the first-type notification windows 104 is established in accordance with the levels of priority of the messages. As a result, the first-type notification window 104 including the message having the highest priority is displayed in the foreground. Thus, the user can be notified about at least the message having the highest priority.

### Second Embodiment

An image forming apparatus 10 according to a second embodiment is the same as that according to the first embodiment, except that a predetermined number of notification windows can be sequentially displayed when multiple notification windows are overlappingly displayed. Thus, the contents different from those of the first embodiment will be described, and redundant description will be omitted.

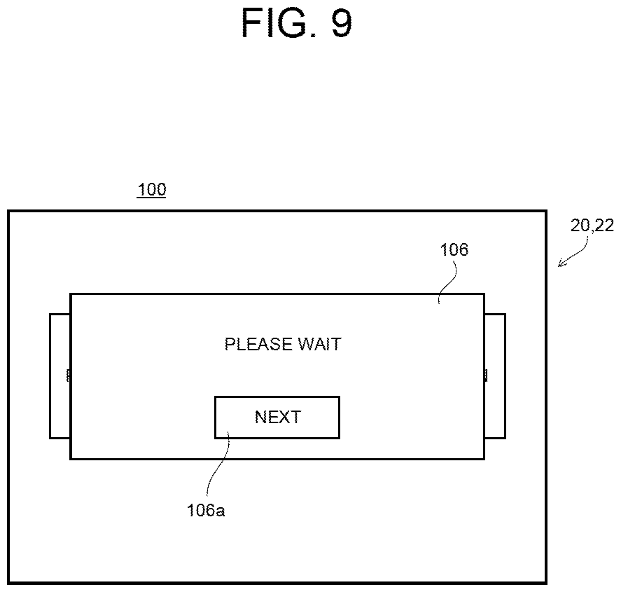

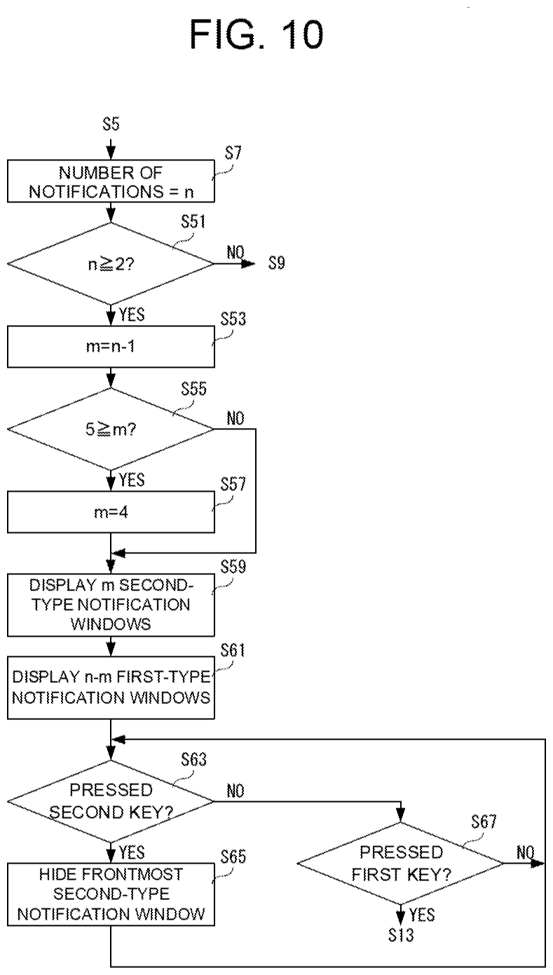

FIG. 9 is an illustrative view of an example of the home menu 100 including a second-type notification window 106 according to the second embodiment. In the image forming apparatus 10 according to the second embodiment, when a user is notified by multiple messages, the display 22 simultaneously displays at least one first-type notification window 104 and at least one second-type notification window 106.

Note that the first-type notification window 104 and the second-type notification window 106 are overlappingly displayed at the same position. The second-type notification window 106 is displayed in front of the first-type notification window 104. Thus, when the first-type notification window 104 and the second-type notification window 106 are first displayed, the second-type notification window 106 is displayed in the foreground.

An upper limit (for example, four) is set for the number of the second-type notification windows 106. Thus, when the number of notifications is equal to or less than the upper limit of the second-type notification windows 106, the window including the message having the lowest level of priority (the rearmost window) is a first-type notification window 104. Thus, in the case where the number of messages displayed to notify the user (the number of notifications) is two or more, the notification windows including the messages having levels of priority from the highest level to a predetermined level are second-type notification windows 106, and the notification windows including messages having levels of priority lower than the predetermined level of priority are first-type notification windows 104. Note that when the number of notifications is one, the notification window including the displayed message is the first-type notification window 104. The upper limit of the number of second-type notification windows 106 is appropriately set in accordance with the installation site, the usage condition, etc., of the image forming apparatus 10.

As illustrated in FIG. 9, a second key 106a is displayed in a second-type notification window 106. The second key 106a is assigned a function of hiding only the frontmost second-type notification window 106. The same applies to the second key 108b described below. Note that the only operation allowed on the second-type notification window 106 is touching the second key 106a, and other operations are prohibited. When multiple second-type notification windows 106 are overlappingly displayed, the only operation allowed is touching the second key 106a of the frontmost second-type notification window 106.

Touching the second key 106a hides only the frontmost second-type notification window 106. That is, the second-type notification window 106 that was the second notification window from the frontmost notification window before the second key 106a was touched (the second-type notification window 106 that was right behind the frontmost second-type notification window 106) is now displayed in the foreground.

When the second notification window from the frontmost window is a second-type notification window 106, touching of the second key 106a in the frontmost second-type notification window 106 causes the next second-type notification window 106 to be displayed in the foreground. When the second notification window from the frontmost notification window is a first-type notification window 104, that is, when the last second-type notification window 106 is being displayed, touching of the second key 106a causes the first-type notification window 104 to be displayed in the foreground. Then, when the first key 104a is touched while the first-type notification window 104 is being displayed in the foreground, all of the first-type notification windows 104 are hidden. In this way, when the number of notifications is two or more, the second-type notification windows 106 and the first-type notification windows 104 are sequentially displayed starting from the second-type notification windows 106 including messages having higher levels of priority.

To achieve the above-described operation in the second embodiment, the control program stored in the RAM 14 of the image forming apparatus 10 includes an acquisition program for acquiring the number of messages (the number of notifications) to be displayed to notify the user, a determination program for determining whether the number of notifications is two or more, and whether the number of notifications is above, below, or equal to the upper limit of the number of the second-type notification windows 106, and the like. The display program 72a is also a program for hiding the frontmost second-type notification window 106 when the second key 106a is touched. The data storage area 74 of the RAM 14 stores data on the number of notifications and data on the upper limit of the number of the second-type notification windows 106. The above-described operation of the image forming apparatus 10 is achieved by the CPU 12 executing a control program including the acquisition program and the determination program.

The notification process according to the second embodiment will now be explained with reference to the flowchart. The steps that are the same as those in the notification process according to the first embodiment are denoted by the same reference signs, and redundant descriptions will be simplified or omitted.

FIG. 10 is a flowchart illustrating a portion of an example of a notification process according to the second embodiment. As illustrated in FIG. 10, when the notification process starts, a CPU 12 substitutes the number of notifications to a variable n in step S7, and determines whether the variable n is equal to two or more, that is, whether the number of notifications is two or more in step S51.

If “NO” in step S51, that is, if the CPU 12 determines that the number of notifications is one, the CPU 12 then performs step S9. If “YES” in step S51, that is, if it is determined that the number of notifications is two or more, the CPU 12 substitutes a variable n−1 to a variable m in step S53, and determines whether the number of notifications is larger than a predetermined number (for example, five), which corresponds to the upper limit of the number of second-type notification windows 106 (for example, four), in step S55.

If “NO” in step S55, that is, if the CPU 12 determines that the number of notifications is smaller than or equal to the upper limit of the number of the second-type notification windows 106, the CPU 12 performs step S59 described below. If “YES” in step S55, that is, if it is determined that the number of notifications is larger than the upper limit of the number of the second-type notification windows 106, the CPU 12 substitutes the upper limit of the second-type notification windows 106 to the variable m in step S57, displays m second-type notification windows 106 on the display 22 in step S59, displays n−m first-type notification windows 104 behind the second-type notification windows 106 in step S61, and determines whether the second key 106a has been touched in step S63.

If “YES” in step S63, that is, if it is determined that the second key 106a has been touched, the CPU 12 hides the frontmost second-type notification window 106 in step S65, and performs step S63 again. If “NO” in step S63, that is, if it is determined that the second key 106a has not been touched, the CPU 12 determines whether the first key 104a has been touched in step S67. If “NO” in step S67, the CPU 12 performs step S63 again. If “YES” in step S67, the CPU 12 perform step S13, hides all of the first-type notification windows 104, and then performs step S1 again.

The contents of the process from steps S1 to S13 are the same as those according to the first embodiment, and thus, description thereof will be omitted. The content of the flag switching process is the same as that according to the first embodiment, and thus description thereof will be omitted.

According to the second embodiment, the frontmost notification window is provided with the second key 106a to which the function of hiding only the frontmost second-type notification window 106 is assigned. Thus, a predetermined number of notification windows can be sequentially displayed, and multiple messages can be displayed to notify the user.

According to the second embodiment, an upper limit is set for the number of notification windows provided with second keys 106a. This is advantageous in that the number of displayed notification windows does not exceed the upper limit, and time and effort are not required for hiding all of the notification windows one by one.

### Third Embodiment

An image forming apparatus 10 according to the third embodiment is the same as that according to the second embodiment, except that multiple messages are ranked in accordance with importance, and notification windows including messages having high importance are displayed with priority. Thus, the contents different from those of the second embodiment will be described, and redundant description thereof will be omitted.

In the image forming apparatus 10 according to the third embodiment, each of the messages is ranked by two levels of importance: a first level of importance (for example, “high level”) and a second level of importance (for example, “low level”). For example, messages having a predetermined level of priority (for example, 100th) and higher are ranked as the first level of importance or the high level, and messages having levels of priority lower than the predetermined level of priority are ranked as the second level of importance or the low level.

When an event corresponding to a message that is ranked as the first level of importance or the high level is occurring in the image forming apparatus 10 according to the third embodiment, a notification window including the message ranked as the first level of importance of the high level is displayed on the display 22. At this time, even if an event corresponding to a message ranked as the second level of importance or the low level is occurring, a notification window including the messages ranked as the second level of importance or the low level is not displayed.

If an event corresponding to a message ranked as the first level of importance or the high level is not occurring, but an event corresponding to a message ranked as the second level of importance or the low level is occurring, a notification window including the message ranked as the second level of importance or the low level is displayed on the display 22.

However, when there are multiple messages ranked as the first level of importance or the high level or multiple messages ranked as the second level of importance or the low level, a predetermined number of the second-type notification windows 106 and first-type notification windows 104 are displayed, and a predetermined number of notification windows are sequentially displayed starting from the notification windows including messages having high levels of priority. If there is only one message ranked as the first level of importance or the high level or the second level of importance or the low level, a first-type notification window 104 including the message is displayed.

Note that the level of importance of each message is determined using the message table illustrated in FIG. 11. FIG. 11 is an illustrative view of an example of a message table according to a third embodiment. As illustrated in FIG. 11, the message table contains messages displayable on the image forming apparatus 10 and the corresponding level of importance and the corresponding levels of priority. For example, the level of priority may be represented by the characters “high” indicating the first level of importance or the characters “low” indicating the second level of importance.

In the third embodiment, the determination program included in the control program stored in the RAM 14 of the image forming apparatus 10 is a program for determining the level of importance of each message, to achieve the above-described operations. The above-described operations of the image forming apparatus 10 are achieved by the CPU 12 executing a control program including the determination program.

The notification process according to the third embodiment will now be explained with reference to the flowchart. The steps that are the same as those in the notification process according to the second embodiment are denoted by the same reference signs, and redundant descriptions thereof will be simplified or omitted.

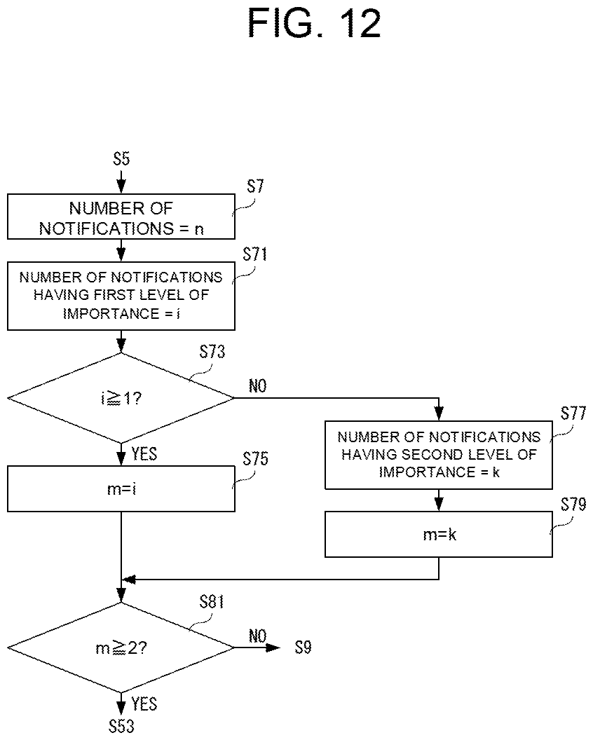

FIG. 12 is a flowchart illustrating a portion of an example of a notification process according to the third embodiment. As illustrated in FIG. 12, when the notification process starts, the CPU 12 substitutes the number of notifications to a variable n in step S7, substitutes the number of notifications ranked as the first level of importance to a variable i in step S71, and determines whether the variable i is larger than or equal to one, that is whether one or more messages are ranked as the first level of importance in step S73. If “YES” in step S73, that is, if it is determined that one or more messages are ranked as the first level of importance, the CPU 12 substitutes the variable i to a variable m in step S75, and then performs step S81 explained below.

If “NO” in step S73, that is, if it is determined that no message is ranked as the first level of importance, the CPU 12 substitutes the number of notifications having the second level of importance to a variable k in step S77, and substitutes the variable k to the variable m in step S79. The CPU 12 then performs step S81.

Subsequently, in step S81, the CPU 12 determines whether the variable m is larger than or equal to two, that is, the number of notifications is larger than or equal to two. If “NO” in step S81, the CPU 12 performs step S9. If “YES” in step S81, the CPU 12 performs step S53.

Note that the contents of the process from steps S1 to S13, step S53, and the subsequent steps are the same as those according to the second embodiment, and thus descriptions thereof will be omitted. The content of the flag switching process is the same as that according to the first embodiment, and thus description thereof will be omitted.

According to the third embodiment, multiple messages are ranked by several levels of importance, and notification windows including messages having high levels of importance are displayed with priority. Thus, the user can be appropriately notified about messages having high levels of importance.

Note that in the third embodiment, each message is ranked as one of the two levels of importance. However, the levels of importance are not necessarily limited thereto. For example, the messages may be ranked by three levels of importance, such as “high,” “intermediate,” and “low,” or may be ranked by four or more levels of importance.

In the third embodiment, when there are multiple messages ranked as the first level of importance or the high level, or multiple messages ranked as the second level of importance or the low level, a predetermined number of the second-type notification windows 106 are displayed. However, the displayed notification windows are not limited thereto. For example, similar to the first embodiment, only the first-type notification windows 104 may be displayed. In such a case, touching the first key 104a of the frontmost first-type notification window 104 hides all of the first-type notification windows 104.

### Fourth Embodiment

An image forming apparatus 10 according to the fourth embodiment is the same as that according to the first embodiment, except that when multiple notification windows are overlappingly displayed, a notification window including a first key and a second key is displayed. Thus, the contents different from those of the first embodiment will be described, and redundant description thereof will be omitted.

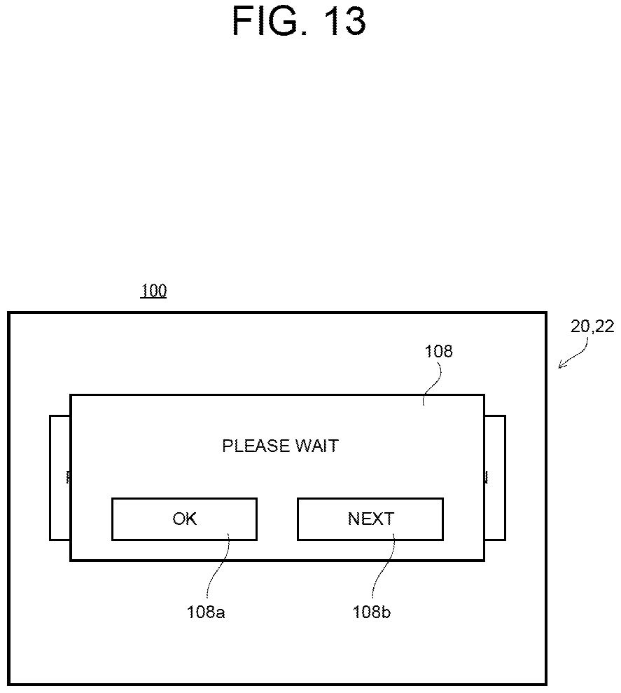

FIG. 13 is an illustrative view of an example of the home menu 100 including a third-type notification window 108 according to the fourth embodiment. In the image forming apparatus 10 according to the fourth embodiment, when the number of notifications is larger than or equal to two, at least one first-type notification window 104 and at least one third-type notification window 108 are simultaneously displayed on the display 22.

Note that the first-type notification window 104 and the third-type notification window 108 are overlappingly displayed at the same position. The third-type notification window 108 is displayed in front of the first-type notification window 104. Thus, when the first-type notification window 104 and the third-type notification window 108 are first displayed, the third-type notification window 108 is displayed in the foreground.

As illustrated in FIG. 13, a first key 108a and a second key 108b are displayed in the third-type notification window 108. The first key 108a is assigned a function of hiding all of the third-type notification windows 108 and first-type notification windows 104, that is, a function of hiding all of the notification windows. The second key 108b is assigned a function of hiding only the frontmost third-type notification window 108.

As described above, the first key 108a has the same function as that of the above-described first key 104a, and the second key 108b has the same function as that of the above-described second key 106a.

Thus, touching the first key 108a hides all of the notification windows including the first-type notification windows 104 and the third-type notification windows 108. Touching the second key 108b hides only the frontmost third-type notification window 108. When the second key 108b is touched in the last third-type notification window 108, that is, when all of the third-type notification windows 108 are hidden, the first-type notification windows 104 is displayed in the foreground.

The notification process according to the fourth embodiment will now be explained with reference to the flowchart. The steps that are the same as those in the notification process according to the first embodiment are denoted by the same reference signs, and redundant descriptions thereof will be simplified or omitted.

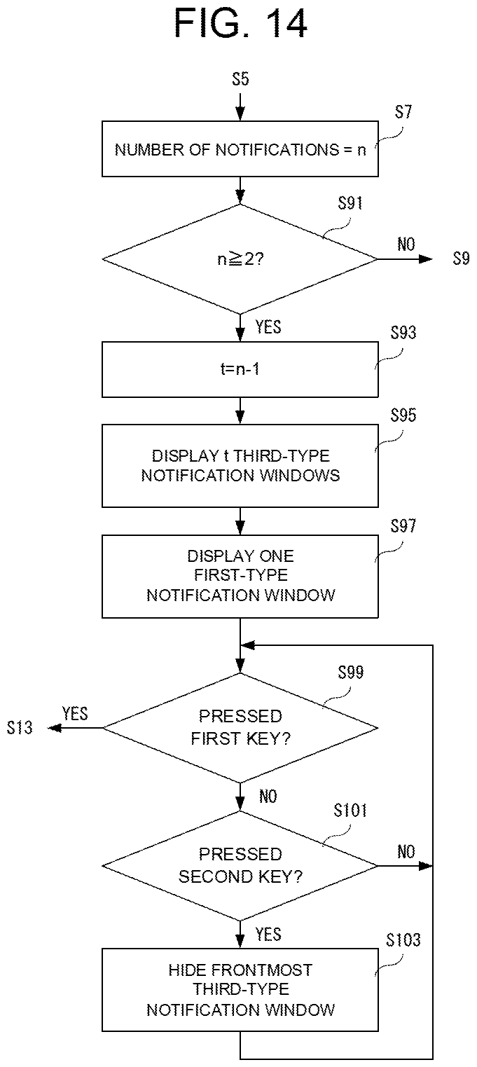

FIG. 14 is a flowchart illustrating a portion of an example of a notification process according to the fourth embodiment. As illustrated in FIG. 14, when the notification process starts, the CPU 12 substitutes the number of notifications to a variable n in step S7, and then, determines whether the variable n is larger than or equal to two in step S91.

If “NO” in step S91, the CPU 12 performs step S9. If “YES” in step S91, the CPU 12 substitutes a variable n−1 to a variable t in step S93, displays t third-type notification windows 108 on the display 22 in step S95, displays one first-type notification window 104 behind the third-type notification windows 108 in step S97, and determines whether the first key 108a has been touched in step S99.

If “NO” in step S99, that is, if it is determined that the first key 108a has not been touched, the CPU 12 performs step S13. If “NO” in step S99, that is, if it is determined that the first key 108a has not been touched, the CPU 12 determines whether the second key 108b has been touched in step S101.

If “NO” in step S101, that is, if it is determined that the second key 108b has not been touched, the CPU 12 performs step S99 again. If “YES” in step S101, that is, if it is determined that the second key 108b has been touched, the CPU 12 hides the frontmost third-type notification window 108 in step S103, and then performs step S99 again.

Note that the contents of the process from steps S1 to S13 are the same as those according to the first embodiment, and thus descriptions thereof will be omitted. The content of the flag switching process is the same as that according to the first embodiment, and thus description thereof will be omitted.

According to the fourth embodiment, when multiple notification windows are overlappingly displayed, a notification window including the first key and the second key is displayed. Thus, there is an advantage in that the user can be notified about multiple notification messages, and all of the notification windows can be hidden at any timing desired by the user.

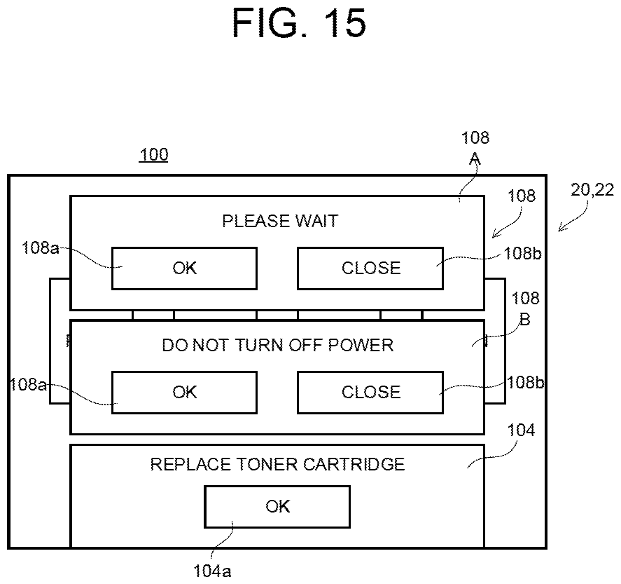

Note that in the fourth embodiment, the first-type notification window 104 and the third-type notification windows 108 are overlappingly display at the same position. However, the notification windows are not necessarily limited thereto. FIG. 15 is an illustrative view of an example of the home menu 100 including third-type notification windows 108 according to a modification. For example, as illustrated in FIG. 15, multiple third-type notification windows 108A and 108B and one first-type notification window 104 may be displayed in an array. In the example illustrated in FIG. 15, a third-type notification window 108A including a message having high priority is displayed above a third-type notification window 108B including a message having low priority. That is, the third-type notification window 108 including the message having the highest priority is displayed at the top. The message having the lowest priority is displayed in a first-type notification window 104. This first-type notification window 104 is displayed at the bottom. Then, when the second key 108b included in the third-type notification window 108 is touched, the third-type notification window 108 is hidden, and the notification window that was displayed below the third-type notification window 108 moves upward. For example, in the example illustrated in FIG. 15, when the second key 108b included in the third-type notification window 108A displayed at the top is touched, the third-type notification window 108A is hidden, and the third-type notification window 108B displayed below the third-type notification window 108A moves upward. At this time, if there are other third-type notification windows 108, a new third-type notification window 108 is displayed below the third-type notification window 108B (i.e., the first-type notification window 104 does not move). If there are no other third-type notification windows 108, the first-type notification window 104 may move upward. In the example illustrated in FIG. 15, multiple third-type notification windows 108 and one first-type notification window 104 are displayed (arranged) so as not to overlap each other. However, these notification windows may be displayed so as to overlap with other notification windows.

The aspect of the fourth embodiment can be adopted in combination with the second embodiment and the third embodiment. In such a case, the second-type notification window 106 is displayed in place of the third-type notification window 108.

### Fifth Embodiment

The image forming apparatus 10 of the fifth embodiment is the same as that according to the first and the fourth embodiments, except that a call-up key is provided for displaying a notification window on the operation menu for a predetermined time after the notification window is hidden by operation of the first key. Thus, the contents different from those of the first embodiment will be described, and redundant description thereof will be omitted.

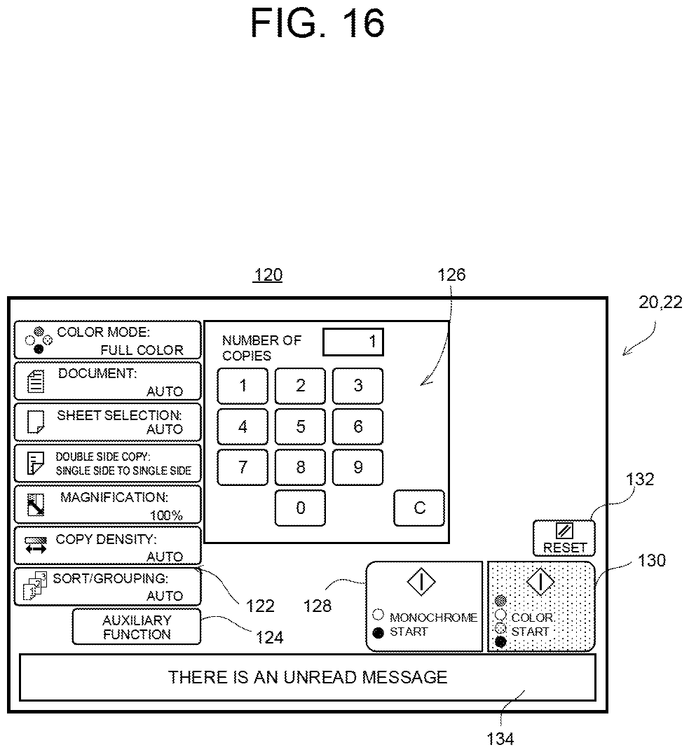

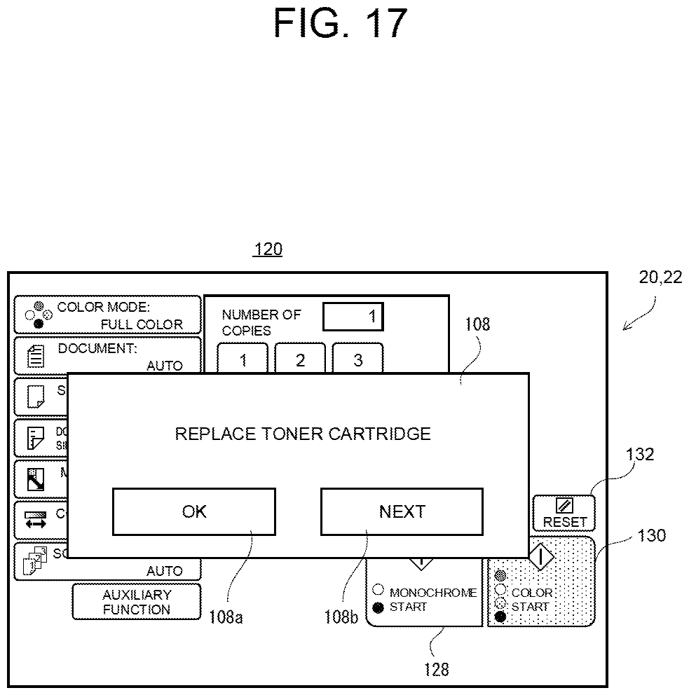

FIG. 16 is an illustrative view of an example of a copy settings menu 120 including a call-up key 134 according to the fifth embodiment. FIG. 17 is an illustrative view of an example of the copy settings menu 120 including a notification window 108 according to the fifth embodiment.

As described above, touching a first key 108a hides all notification windows. Notification windows are not displayed during a predetermined time immediately after the first key 108a is touched. Selecting a copy job on the home menu 100 in this state displays the copy settings menu 120, such as that illustrated in FIG. 16, on the display 22. The copy settings menu 120 is a menu for setting operation conditions of a copy job.

The copy settings menu 120 displays software keys, such as function selection keys 122, an auxiliary-function selection key 124, a numeric keypad 126, a monochrome start key 128, a color start key 130, a reset key 132, and a call-up key 134.

The function selection keys 122 are displayed on the left end of the copy settings menu 120. The function selection keys 122 are provided in plurality. Each of the function selection keys 122 corresponds to a main operating condition or a main function of the copy job. The copy settings menu 120 displays the auxiliary-function selection key 124 for detailed settings of each of the functions (auxiliary functions) other than the above-described main functions.

The numeric keypad 126 includes numeric keys, and is provided in a setting area for the number of copies displayed in the central region of the copy settings menu 120. Touching the numeric keypad 126 causes a number corresponding to the touched numeric key to be displayed in the ten key input display field above the numeric keypad 126. That is, the number of copies is selected.

The monochrome start key 128 and the color start key 130 are displayed in the lower right corner region of the copy settings menu 120. The monochrome start key 128 and the color start key 130 are keys for causing the image forming apparatus 10 to start predetermined operations. Touching the monochrome start key 128 on the copy settings menu 120 starts monochrome copying, and touching the color start key 130 on the copy settings menu 120 starts color copying in accordance with color settings.

The reset key 132 is displayed above the color start key 130 at the right end of the copy settings menu 120. The reset key 132 is a key for initializing the operation conditions of a copy job. For example, touching the reset key 132 initializes the settings of operation conditions (including various functions) of the copy job selected on the copy settings menu 120.

The call-up key 134 is displayed when an event about which the user should be notified is occurring, that is, when a message corresponding to the event occurring in the image forming apparatus 10 is selected (the number of notifications is one or more), and is a key for displaying the notification windows hidden by touching the first key 108a.

For example, touching the call-up key 134 displays a notification window. When multiple events are simultaneously occurring, multiple notification windows are displayed, as illustrated in FIG. 17. In the example illustrated in FIG. 17, a third-type notification window 108 is displayed, and a first-type notification window 104 is displayed behind the third-type notification window 108. The third-type notification window 108 is displayed in the foreground. Then, touching the first key 108a hides all of the notification windows, and touching the second key 108b hides only the frontmost third-type notification window 108.

In the fifth embodiment, the display program 72a is also a program for displaying a notification window when the call-up key 134 is touched in order to achieve the above-described operation. The above-described operation of the image forming apparatus 10 is achieved by the CPU 12 executing the control program.

The notification process and the flag switching process according to the fifth embodiment will now be explained with reference to the flowcharts. The steps that are the same as those in the notification process according to the fourth embodiment and the flag switching process according to the first embodiment are denoted by the same reference signs, and redundant descriptions thereof will be simplified or omitted.

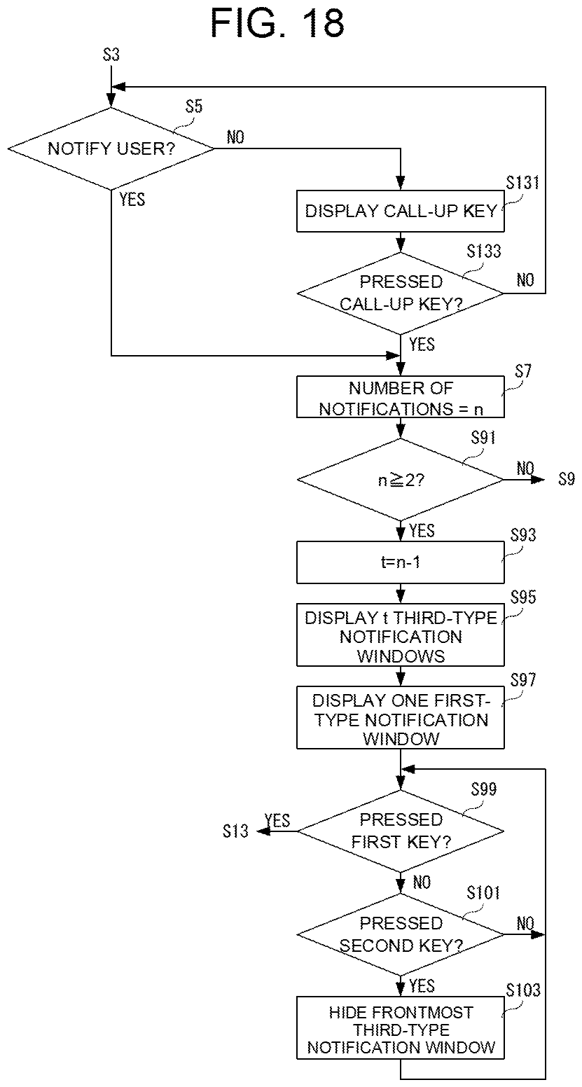

FIG. 18 is a flowchart illustrating a portion of an example of a notification process according to the fifth embodiment. As illustrated in FIG. 18, the CPU 12 starts the notification process, and then if “NO” in step S5, that is, if the CPU 12 determines that the display flag 74d is turned off and a notification is not to be made, the CPU 12 displays the call-up key 134 in step S131, and determines whether the call-up key 134 has been touched in step S133. If “NO” in step S133, that is, if it is determined that the call-up key 134 has not been touched, the CPU 12 then performs step S5 again. If “YES” in step S133, that is, if it is determined that the call-up key 134 has been touched, the CPU 12 then performs step S7.

Note that the contents of the process from steps S1 to S5, and step S7 and the subsequent steps are the same as those according to the fourth embodiment, and thus the description thereof will be omitted.

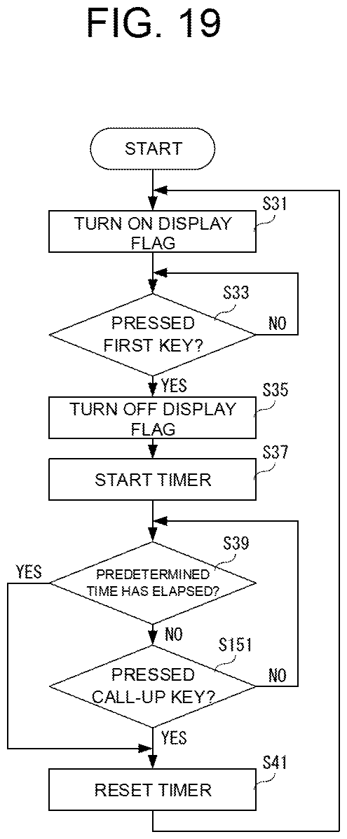

The flag switching process according to the fifth embodiment will now be described. FIG. 19 is a flowchart illustrating an example of a flag switching process according to the fifth embodiment. As illustrated in FIG. 19, the CPU 12 starts the flag switching process, and then if “NO” in step S39, that is, if the predetermined time has not elapsed, the CPU 12 determines whether the call-up key 134 has been touched in step S151. If “NO” in step S151, that is, if it is determined that the call-up key 134 has not been touched, the CPU 12 performs step S39 again. If “YES” in step S151, that is, if it is determined that the call-up key 134 has been touched, the CPU 12 then performs step S41.

Note that the contents of the process from steps S1 to S39 and step S41 are the same as those according to the first embodiment, and thus descriptions thereof will be omitted.

According to the fifth embodiment, the call-up key for displaying a notification window is displayed for a predetermined time immediately after the notification window is hidden by the operation of the first key. Thus, the user can determine the timing at which a notification window is to be displayed and confirm a message in a convenient manner.

The aspect of the fifth embodiment can be adopted in combination with the second and third embodiments. In such a case, the second-type notification window 106 is displayed in place of the third-type notification window 108.

Note that the specific configurations, etc., according to the above-described embodiments are merely examples, and it is possible to make appropriate modifications depending on the actual product. Each step in the flowcharts described in the above-mentioned embodiments can be appropriately changed in the processing order as long as the same result is obtained. Furthermore, characters and the like included in the software key in the drawings are merely examples, and can be appropriately modified.

In the above-described embodiments, the operation keys, such as the first keys 104a and 108a, the second keys 106a and 108b, and the call-up key 134, are software keys operated by touch input to the touch panel 20. However, the operation keys are not necessarily limited thereto. For example, the operation keys may be operated by a pointing device, such as a computer mouse, a touch pad, a pen tablet, and the like. Alternatively, the operation key may be a hardware key. For example, predetermined keys included in the operation button 26a may function as the first key the second key and the call-up key. Alternatively in the case where a keyboard is connected to the image forming apparatus 10, predetermined keys included in the keyboard may function as the first key, the second key, and the call-up key.

Furthermore, in the above-described embodiments, when a predetermined event involving the image forming apparatus 10 is occurring and when the user should be notified of the predetermined event, a notification window includes a message corresponding to the information on the event. However, the message is not necessarily limited thereto. For example, in the case where the present invention is applied to an information device having an image display function and a display device, such as an information display or an electronic blackboard, a notification window may include a message about an event involving the information device and the display device, a message about an event involving an external device connected with the information device and the display device, and the like.

What is claimed is:

1. A display device comprising:
a display that has a display surface;
a notifier that displays windows including messages on the display surface; and
a display controller that hides all of the windows displayed on the display surface when a first key provided on at least one of the windows is operated.

2. The display device according to claim 1, wherein
the notifier overlappingly displays the windows, and
the first key is provided on at least a frontmost window.

3. The display device according to claim 2, wherein
each of the messages is assigned a level of priority, and
the notifier displays the windows in an order of display corresponding to the levels of priority of the messages included in the windows.

4. The display device according to claim 2, wherein
a frontmost window is provided with a second key, and
the display controller hides the frontmost window when the second key is operated.

5. The display device according to claim 1, wherein
at least one of the windows is provided with a second key, and
the display controller hides the window provided with the second key when the second key is operated.

6. The display device according to claim 5, wherein at least one of the windows is provided with the first key and the second key.

7. An image forming apparatus comprising the display device according to claim 1, wherein the display device includes the notifier that displays, on the display surface, windows including messages corresponding to events involving the image forming apparatus, while the events are occurring.

8. A storage medium storing a control program for a display device including a display having a display surface, the control program causing a processor of the display device to function as:
a notifier that displays windows including messages on the display surface; and
a display controller that hides all of the windows displayed on the display surface when a first key provided on at least one of the windows is operated.

9. A method of controlling a display device including a display having a display surface, the method comprising:
(a) displaying windows including messages on the display surface; and
(b) hiding all of the windows displayed on the display surface when a first key provided on at least one of the windows is operated.
